(19) United States
(12) Patent Application Publication
(10) Pub. No.: US 2023/0245078 A1
(43) Pub. Date: Aug. 3, 2023

(54) SYSTEM AND METHOD FOR MANAGEMENT OF DATA EXCHANGE WITH MULTIPLE PROTOCOLS IN A COMPUTER NETWORK

(71) Applicant: SensePass LTD., Ness Ziona (IL)

(72) Inventors: Chen COHEN, Ness Ziona (IL); Nir ALPEROVICH, Tel Aviv (IL); Moty ARCUSCHIN, Tel Aviv (IL)

(73) Assignee: SensePass LTD., Ness Ziona (IL)

(21) Appl. No.: 18/004,925

(22) PCT Filed: Jul. 12, 2021
(86) PCT No.: PCT/IL2021/050851

§ 371 Date: Jan. 10, 2023

Related U.S. Application Data
(63) Continuation of application No. 16/926,707, filed on Jul. 12, 2020, now abandoned.

(51) Int. Cl. G06Q 20/02; G06Q 20/36; G06F 16/25; H04L 69/08; G06Q 20/40

(52) U.S. Cl. CPC G06Q 20/02; G06Q 20/3674; G06Q 20/3678; G06F 16/258; H04L 69/08; G06Q 20/4037; G06Q 20/326

(57) ABSTRACT

Systems and methods of converting payment protocols, including: sending a transaction request to a computing device, wherein the transaction request is associated with a first protocol, determining based on the received transaction request, a type of the first protocol, determining a second protocol, wherein the type of the second protocol is determined based on the received transaction request, determining a characteristic of the received transaction request, and converting the received transaction request from the first protocol into the second protocol, wherein the conversion is carried out based on a predefined conversion protocols database.

### FIELD OF THE INVENTION

The present invention relates to data conversion. More particularly, the present invention relates to systems and methods for converting data with multiple protocols during data exchange.

### BACKGROUND OF THE INVENTION

In recent years, technological developments in the payment domain typically provide a variety of different payment methods for merchants as well as for consumers. For example, a merchant is able to offer customers several options for payment at the point of sale, such as via credit cards, debit cards or mobile wallet apps using credit cards or debit cards (e.g., ApplePay®, GooglePay®, etc.). However, new digital payment methods and payment apps can require integration with the point of sale in order to, for example, become accepted as a payment method.

As the number of technological solutions for payments increases, the number of the used communication protocols, algorithms, etc., can increase accordingly. For instance, various manufacturers of point of sale terminals (e.g., digital cash registers) may offer different devices for the merchants, where each available device can work with several payment methods. Sometimes, the same point of sale terminal may operate with different versions (e.g., different versions of operating system) such that different types of payment methods may be available for each different version. Typically, the same point of sale terminals are connected to several separate devices, where each such device can allow payment by a different method (e.g., via a dedicated credit card terminal with a PIN pad). Thus, the merchant can be required to keep updating their point of sale devices in order to, for example, allow a wider range of payment methods.

For example, a chain of coffee shops that wants to allow its customers the option of paying with a dedicated mobile wallet app, needs to ask the manufacturer of their point of sale terminals to update the software in each of these terminals. Such updates are usually carried out on site by a technician of the terminals and can accordingly add cost to the manufacturer for the update of the software as well as the working hours of the technician.

### SUMMARY

There is thus provided, in accordance with some embodiments of the invention, a method of converting payment protocols, the method including: sending, by a first computing device, a transaction request to a second computing device, wherein the transaction request, received by the second computing device, is associated with a first protocol, determining, by the second computing device, based on the received transaction request, a type of the first protocol, determining, by the second computing device, a second protocol, wherein the type of the second protocol is determined based on the received transaction request, determining a characteristic of the received transaction request, wherein the characteristic includes at least one of: a physical connection through which the transaction request is received, a communication rate of the first protocol, a number of received transmissions for the received transaction request, and at least one predetermined character within the transaction request, and converting the received transaction request from the first protocol into the second protocol, wherein the conversion is carried out based on a predefined conversion protocols database.

In some embodiments, the conversion from the first protocol into the second protocol includes: converting the transaction request from the first protocol into a third protocol, and converting the transaction request from the third protocol into the second protocol, wherein the conversion is carried out based on the predefined conversion protocols database. In some embodiments, the type of the second protocol is predefined for all transactions.

In some embodiments, a characteristic of the received transaction request in the second protocol is determined for at least one of: a physical connection through which the transaction request is received, a communication rate of the first protocol, a number of received transmissions for the received transaction request, and at least one predetermined character within the transaction request, wherein the determined characteristic is different in the first protocol and the second protocol. In some embodiments, the type of the second protocol is predefined for all transactions.

In some embodiments, the transaction via at least one payment server is confirmed. In some embodiments, the confirmation of the transaction is sent to validation by at least one transaction server, wherein the at least one transaction server is associated with the second computing device. In some embodiments, the payment server is associated with at least one digital wallet.

There is thus provided, in accordance with some embodiments of the invention, a method of carrying out a transaction with a digital wallet, the method including: receiving, by a terminal, a transaction request from a first computing device, based on a first protocol, converting, by the terminal, the transaction request from the first protocol into “N” different protocols, wherein the conversion is carried out based on a predefined conversion protocols database, and wherein “N” is a natural number, transmitting, by the terminal, the converted transaction request in “N” protocols, receiving, by a mobile computing device, the transmitted converted transaction request, confirming, by the mobile computing device, the transaction with a payment server, wherein confirmation of the transaction includes validating an account balance of a digital wallet associated with the mobile computing device and associated with the payment server, and carrying out the transaction, by the terminal, upon confirmation by the mobile computing device.

In some embodiments, the conversion from the first protocol into “N” protocols includes converting the transaction request from the first protocol into a third protocol, and converting the transaction request from the third protocol into the “N” protocols, wherein the conversion is carried out based on the predefined conversion protocols database.

In some embodiments, information of the transaction received by the terminal is selected from the group consisting of: an amount for the transaction, a time and date of the transaction, and an item associated with the transaction, and the received information is validated by the mobile computing device.

In some embodiments, a characteristic of the received transaction request is defined for at least one of: a physical connection through which the transaction request is received, a communication rate of the first protocol, a number of received transmissions for the received transaction request, at least one predetermined character within the transaction request, wherein the determined characteristic is different in the first protocol and in the converted “N” protocols.

In some embodiments, the transaction is carried out by the terminal, upon confirmation by the mobile computing device, when at least one transaction server validates the transaction. In some embodiments, the type of the first protocol is analyzed from the received transaction request. In some embodiments, the payment server is associated with at least one digital wallet.

There is thus provided, in accordance with some embodiments of the invention, a terminal including: a processor, and a predefined conversion protocols database, coupled to the processor, wherein the processor is configured to: receive a transaction request from a first computing device, based on a first protocol, convert the transaction request from the first protocol into “N” different protocols, wherein the conversion is carried out based on the predefined conversion protocols database, and wherein “N” is a natural number, transmit the converted transaction request in “N” protocols to be received by the second computing device, carry out the transaction, by the terminal, upon confirmation by a second computing device with a payment server, wherein confirmation of the transaction includes validating an account balance of a digital wallet associated with the second computing device and associated with the payment server.

In some embodiments, the processor is configured to: convert the transaction request from the first protocol into a third protocol, and convert the transaction request from the third protocol into the “N” protocols, wherein the conversion is carried out based on the predefined conversion protocols database. In some embodiments, the processor is configured to: receive information of the transaction selected from the group consisting of: an amount for the transaction, a time and date of the transaction, and an item associated with the transaction, and validate the received information by the mobile computing device.

In some embodiments, the processor is configured to determine a characteristic of the received transaction request, for at least one of: a physical connection through which the transaction request is received, a communication rate of the first protocol, a number of received transmissions for the received transaction request, at least one predetermined character within the transaction request, wherein the determined characteristic is different in the first protocol and in the converted “N” protocols. In some embodiments, the processor is configured to carry out the transaction, by the terminal, upon confirmation by the mobile computing device, when at least one transaction server validates the transaction.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a block diagram of an exemplary computing device, according to some embodiments of the invention;

FIG. 2A shows a block diagram of a system for conversion of payment protocols, according to some embodiments of the invention;

FIG. 2B shows a block diagram of the system for conversion of payment protocols coupled to another computing device, according to some embodiments of the invention;

FIG. 2C shows a flowchart of a method of converting payment protocols, according to some embodiments of the invention;

FIG. 3 shows a block diagram of the system for conversion of payment protocols with a protocol conversion terminal, according to some embodiments of the invention;

FIG. 4 shows a block diagram of the system for conversion of payment protocols with a dedicated third protocol, according to some embodiments of the invention;

FIG. 5 shows a block diagram of the system for conversion of payment protocols with a dedicated transaction server, according to some embodiments of the invention;

FIG. 6A show a flowchart of a method of carrying out a transaction with a digital wallet, according to some embodiments of the invention; and

FIG. 6B shows a continuation of the flowchart from FIG. 6A, according to some embodiments of the invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

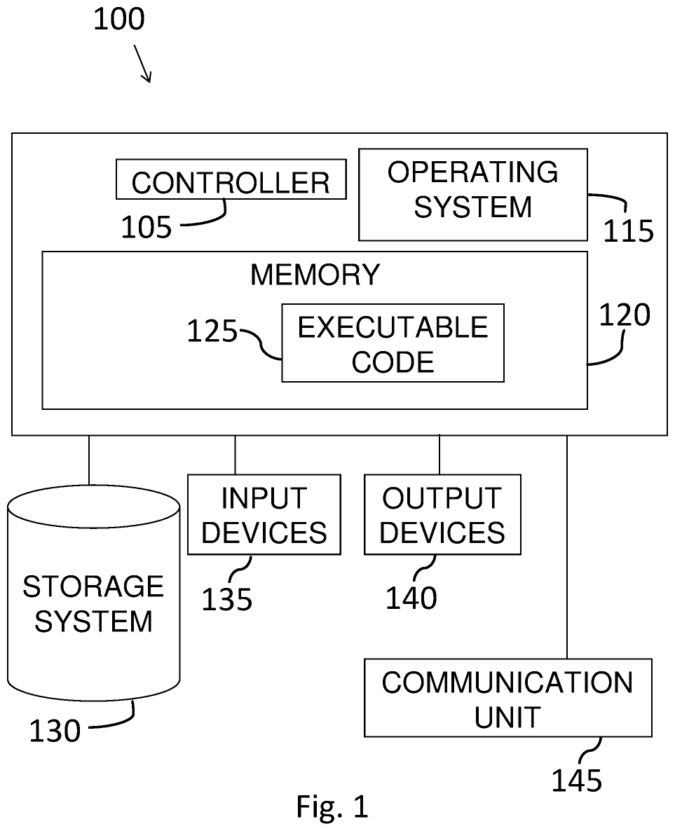

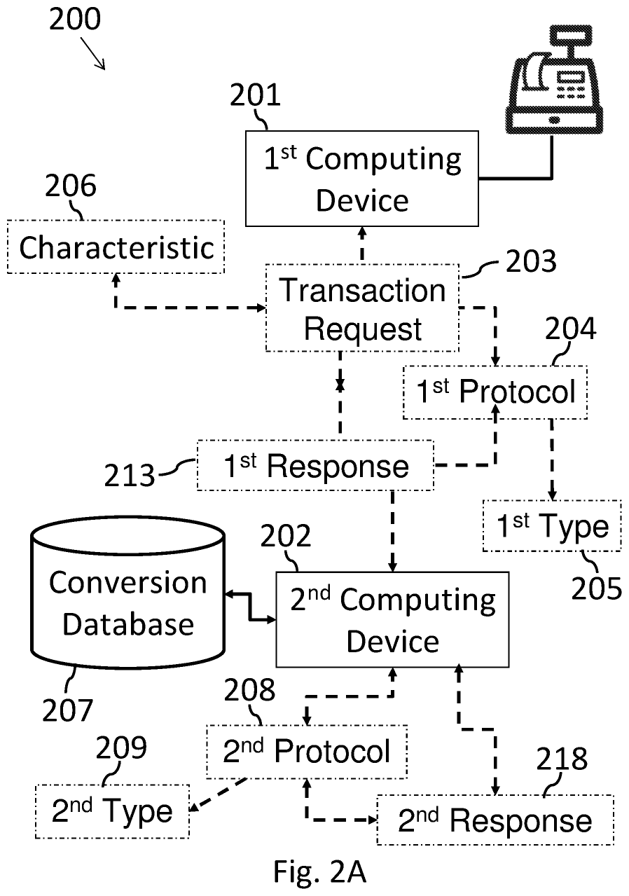

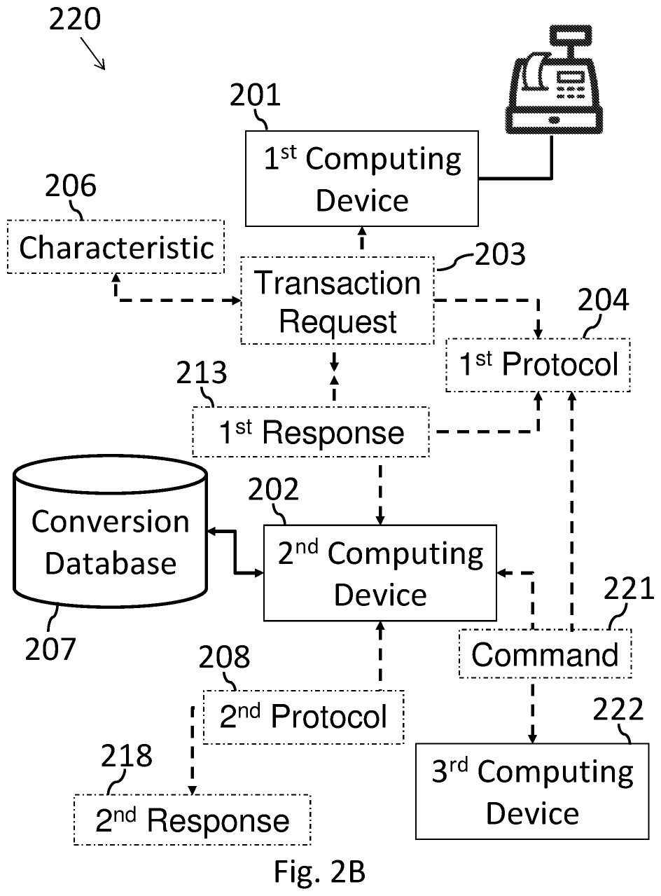

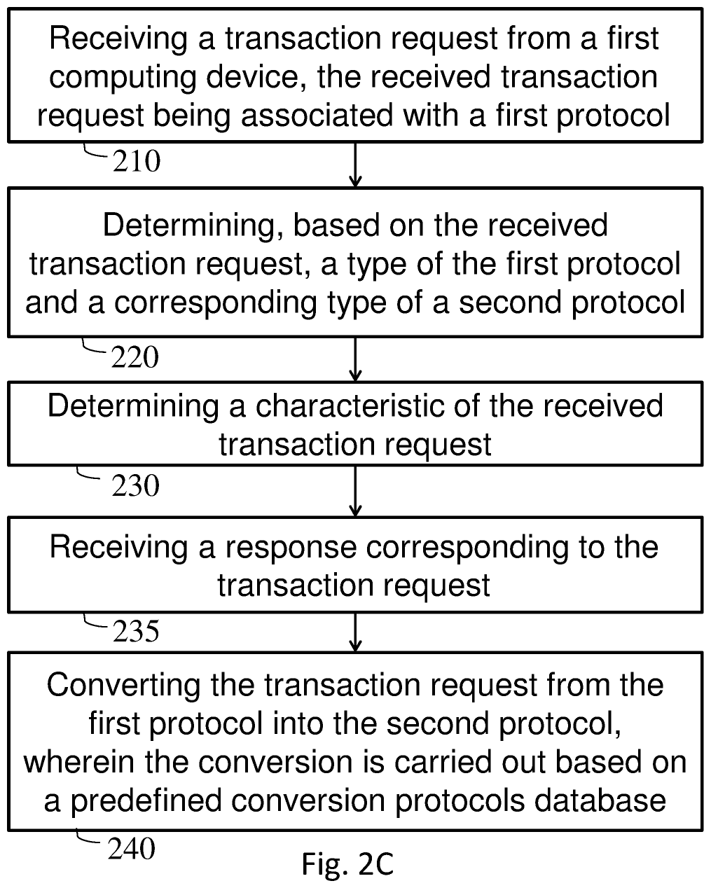

Reference is made to FIG. 1, which is a schematic block diagram of an example computing device 100, according to some embodiments of the invention. Computing device 100 may include a controller or processor 105 (e.g., a central processing unit (CPU), a programmable controller or any suitable computing or computational device), memory 120, storage 130, input devices 135 (e.g. a keyboard or touchscreen), and output devices 140 (e.g., a display), a communication unit 145 (e.g., a cellular transceiver or modem, a Wi-Fi communication unit, or the like) for communicating with remote devices via a communication network, such as, for example, the Internet. The computing device 100 may operate by executing an operating system 115 and/or executable code 125. Controller 105 may be configured to execute program code to perform operations described herein. The system described herein may include one or more computing device 100, for example, to act as the various devices or the components shown in FIG. 2A. For example, system 200 may be, or may include a computing device (e.g. computing device 201) similar to computing device 100, or components thereof.

Operating system 115 may be or may include any code segment (e.g., one similar to executable code 125 described herein) designed and/or configured to perform tasks involving coordinating, scheduling, arbitrating, supervising, controlling or otherwise managing operation of computing device 100, for example, scheduling execution of software programs or enabling software programs or other modules or units to communicate.

Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may be a computer or processor non-transitory readable medium, or a computer non-transitory storage medium, e.g., a RAM.

Executable code 125 may be any executable code, e.g., an application, a program, a process, task or script. Executable code 125 may be executed by controller 105 possibly under control of operating system 115. For example, executable code 125 may be a software application that performs methods as further described herein. Although, for the sake of clarity, a single item of executable code 125 is shown in FIG. 1, a system according to some embodiments of the invention may include a plurality of executable code segments similar to executable code 125 that may be stored into memory 120 and cause controller 105 to carry out methods described herein.

Storage 130 may be or may include, for example, a hard disk drive, a universal serial bus (USB) device or other suitable removable and/or fixed storage unit. In some embodiments, some of the components shown in FIG. 1 may be omitted. For example, memory 120 may be a non-volatile memory having the storage capacity of storage 130. Accordingly, although shown as a separate component, storage 130 may be embedded or included in memory 120.

Input devices 135 may be or may include a keyboard, a touch screen or pad, one or more sensors or any other or additional suitable input device. Any suitable number of input devices 135 may be operatively connected to computing device 100. Output devices 140 may include one or more displays or monitors and/or any other suitable output devices. Any suitable number of output devices 140 may be operatively connected to computing device 100. Any applicable input/output (I/O) devices may be connected to computing device 100 as shown by blocks 135 and 140. For example, a wired or wireless network interface card (NIC), a universal serial bus (USB) device or external hard drive may be included in input devices 135 and/or output devices 140.

Some embodiments of the invention may include an article such as a computer or processor non-transitory readable medium, or a computer or processor non-transitory storage medium, such as for example a memory, a disk drive, or a USB flash memory, which may encode, include or store instructions, e.g., computer-executable instructions, which, when executed by a processor or controller, carry out methods disclosed herein. For example, an article may include a storage medium such as memory 120, computer-executable instructions such as executable code 125 and a controller such as controller 105. Such a non-transitory computer readable medium may be, for example, a memory, a disk drive, or a USB flash memory, encoding, including or storing instructions, e.g., computer-executable instructions, which, when executed by a processor or controller, carry out methods disclosed herein. The storage medium may include, but is not limited to, any type of disk including, semiconductor devices such as read-only memories (ROMs) and/or random-access memories (RAMs), flash memories, electrically erasable programmable read-only memories (EEPROMs) or any type of media suitable for storing electronic instructions, including programmable storage devices. For example, in some embodiments, memory 120 is a non-transitory machine-readable medium.

A system according to some embodiments of the invention may include components such as, but not limited to, a plurality of central processing units (CPU) or any other suitable multi-purpose or specific processors or controllers (e.g., controllers similar to controller 105), a plurality of input units, a plurality of output units, a plurality of memory units, and a plurality of storage units. A system may additionally include other suitable hardware components and/or software components. In some embodiments, a system may include or may be, for example, a personal computer, a desktop computer, a laptop computer, a workstation, a server computer, a network device, or any other suitable computing device. For example, a system as described herein may include one or more facility computing device 100 and one or more remote server computers in active communication with one or more facility computing device 100 such as computing device 100, and in active communication with one or more portable or mobile devices such as smartphones, tablets and the like.

Reference is now made to FIG. 2A, which shows a block diagram of a system 200 for conversion of payment protocols, according to some embodiments. In FIG. 2A, hardware elements are indicated with a solid line and the direction of arrows may indicate the direction of information flow.

The system 200 may include a first computing device 201 (e.g., such as the controller 105 shown in FIG. 1), for example positioned at a point of sale. The system 200 may include a second computing device 202 configured to communicate with the first computing device 201, for instance communicate wirelessly (e.g., using BLE, NFC, or with a dedicated sensor to read barcode, QR code, etc.), for instance via a secured communication channel. In some embodiments, a transaction initiated in a first protocol at the first computing device 201 passes to the second computing device 202 with conversion of the first protocol to a second protocol, as further described hereinafter. With the protocol conversion feature, the system 200 may allow to carry out transactions in additional methods/protocols (e.g., digital wallets) for any computing device. For example, the second computing device 202 may be a mobile computing device such as a smartphone. In another example, by providing a single computing device that can communicate with different payment servers (e.g., using protocol conversion), a technological advantage mat be provided with a way for anyone to pay with their digital wallet app at any point of sale where such dedicated terminal is installed.

In some embodiments, the second computing device 202 includes different hardware and/or software components compared to the first computing device 201 (e.g., a digital cash register), where each of the first and second computing devices is provided by a different manufacturer. For example, the second computing device 202 may be a credit card terminal that communicates with a bank acting as an issuer of credit cards, such that the bank communicates with a credit card server to confirm the transaction (e.g., check that the required amount can be deducted from a particular card's account). All transactions in a particular day may be batched together such that the issuer bank may carry them out together at the end of the day.

In some embodiments, the second computing device 202 is an existing device (e.g., a credit card terminal) with added dedicated software in order to allow communication with the proper entity in order to complete the transaction with payment methods that were not available before. For example, a dedicated software may be embedded at the second computing device 202 with an algorithm to convert the first protocol 204 to a different protocol in order to communicate with new entities using the different protocols. Thus, any point of sale may use such an algorithm in order to carry out transactions with digital wallets, without the need to process the transaction with a bank or credit card server for instance.

The first computing device 201 may receive a transaction request 203 and communicate that transaction request 203 to the second computing device 202. For example, the first computing device 201 may be positioned at a point of sale (e.g., at a store) and receive (manually or automatically) a request 203 to initiate a transaction, such a request may include an amount to be paid to complete a transaction. In some embodiments, the second computing device 202 receives the transaction request 203, and return a corresponding response 213 (in the first protocol 204) to the first computing device 201.

In some embodiments, the transaction request 203 is associated with a first protocol 204. The first protocol 204 may be any protocol used for carrying out transactions, such as a communication protocol used between cash registers and credit card terminals, where the credit card terminal receives a request 203 to deduct a particular sum from a credit card's account and asks for confirmation of the transaction from a remote credit card server.

Since various manufacturers of such computing devices can use different protocols, the effort and/or cost of adding a new protocol to such a computing device (e.g., embedding new update at a point of sale cash register) may be particularly substantial. Thus, if the system 200 allows communication between the first computing device 201 and additional transaction entities (e.g., credit card servers or digital wallets), by converting between the protocols it can be avoided to integrate new dedicated software into every first computing device 201 (e.g., for every single type of new transaction method). Since no new software is integrated into the first computing device 201, it may be possible to save memory and/or processing resources of the first computing device 201.

For example, some mobile apps enable transactions with credit account that is associated with a bank account or a credit card account, and some mobile apps enable transactions with digital wallets (e.g., PayPal™) with a balance of a currency that allows to conduct transactions with such a balance (without the usage of a credit card). Thus, if the system 200 uses a dedicated algorithm to convert the first protocol 204 into a protocol that can communicate with a server for digital wallets, where no bank and/or credit card is involved, then it may be sufficient to embed the dedicated software/hardware once instead adding dedicated terminal to the system and/or requiring integration with new software by the manufacturer of the first computing device 201 (e.g., a cash register).

In some embodiments, a first type 205 of the first protocol 204 and a corresponding second type 209 of a second protocol 208 are determined (e.g., by the second computing device 202) based on the received transaction request 203. For example, the transaction request 203 may include information for the first type 205 and/or for the second type 209. In another example, the transaction request 203 may include additional information such as the amount to be transferred in the transaction, or the desired time/date to complete the transaction. In order to carry out the conversion between protocols, the second computing device 202 may receive the first type 205 and/or the second type 209. According to some embodiments, the second computing device 202 receives a second response 218 in the second protocol 208, similarly to the first response 213 received in the first protocol 204. For example, the second computing device 202 may receive confirmation of the transaction as the second response 218 in the second protocol 209, and convert the received confirmation 218 to the first protocol 204 in order to send the second response 218 to the first computing device 201.

According to some embodiments, a general protocol conversion is applied the same (static) conversion for each received first type 205 of the first protocol 204. For instance, the second computing device 202 may only receive the first type 205, based on the received transaction request 203, and convert to a predefined second type of protocol. The predefined second type of protocol (e.g., predefined for all transactions) may be a protocol type dedicated to transactions and/or protocols configured to be processed by the second computing device 202. For example, the predefined second type of protocol may be a protocol type dedicated to transactions with digital wallets. Thus, the system 200 may allow transaction for different types of protocols (e.g., using different mobile payment apps associated with digital wallets) at any location (e.g., a point of sale) with a suitable first computing device 201.

It should be noted that while the digital wallet example is mostly provided hereinafter, the same may apply for other payment methods, such as wallet apps, payment platforms based on account balance and/or loyalty points, etc.

In some embodiments, the conversion from the first type of protocol 205 to the second type of protocol 209 is carried out (e.g., by the second computing device 202) based on a predefined protocol conversion algorithm stored in database 207. For example, the protocol conversion algorithm stored in database 207 may include translation information (e.g., similarly to a dictionary) to convert the first protocol 204 into the second protocol 208. For instance, similarly to a dictionary with translations between protocols.

In some embodiments, a characteristic 206 of the received transaction request 203 is determined (e.g., by the second computing device 202). The characteristic 206 may be determined for at least one of: a physical connection (e.g., a serial port number) through which the transaction request 203 is received, and/or a communication rate of the first protocol 204, and/or a number of received transmissions for the received transaction request 203, and/or at least one predetermined character within the transaction request 203, and/or a predefined protocol type 205, 209 (e.g., a static configuration for the second protocol). In some embodiments, the determined characteristic 206 is different in the first protocol 204 and in the second protocol 208. For example, a desired data structure of the second protocol 208 (e.g., a destination protocol) may be different than the first protocol 204 (e.g., the origin protocol).

According to some embodiments, the second computing device 202 converts the transaction request 203 from the first protocol 204 into the second protocol 208. For example, if the first protocol 204 has a “credit card” protocol type 205, and the second protocol 208 has a “digital wallet” protocol type 209, then the second computing device 202 may convert the transaction request 203 to a digital wallet transaction.

Reference is now made to FIG. 2B, which shows a block diagram of a system 220 for conversion of payment protocols coupled to a third computing device 222, according to some embodiments. In FIG. 2B, hardware elements are indicated with a solid line and the direction of arrows may indicate the direction of information flow. Some of the elements shown in FIG. 2B may be similar to the elements shown in FIG. 2A, for instance the first computing device 201.

According to some embodiments, the second computing device 202 is configured to be coupled to a third computing device 222. For example, the third computing device 222 may be a dedicated payment terminal for specific payment methods (e.g., a credit card terminal such as an EMV terminal).

When the transaction request 203 is initiated by the first computing device 201, the user of the system 220 may select to complete the transaction with a particular payment method (e.g., using digital wallets) that is not possible with the third computing device 222. The transaction request 203 may be automatically issued (for each transaction) by the first computing device 201 to the third computing device 222, where the second computing device 202 may server as an intermediate computing device (e.g., intermediate in communication transfer) between the first computing device 201 and the third computing device 222.

In some embodiments, the second computing device 202 receives the transaction request 203 for processing, including conversion to the second protocol 208 and receiving a corresponding second response 218. The second computing device 202 may accordingly convert the second response 218 to the first protocol 204 in order to send to the first computing device 201. In order to make sure that transaction is not carried out simultaneously by the third computing device 222, the second computing device 202 may send a command 221 (e.g., a cancelation command) to the third computing device 222 upon receipt of the second response 218.

For example, a regular credit-card transaction may include the first computing device 201 issuing the transaction request 203, in the first protocol 204, to the third computing device 222 (e.g., an EMV terminal). Using the system 220, the user may utilize additional payment methods with the second computing device 202. The second computing device 202 may convert to the second protocol 208 and confirm the transaction (e.g., with payment via digital wallets). In order to make sure that the third computing device 222 does not proceed to payment, when the second computing device 202 processes the transaction, the cancellation command 221 may be issued to the third computing device 222.

In some embodiments, the command 221 is sent to the third computing device 222 in the first protocol 204, since the first computing device 201 may only communicate in the first protocol 204 with the second computing device 202 and/or with the third computing device 222.

Reference is now made to FIG. 2C, which shows a flowchart of a method of converting payment protocols, according to some embodiments.

In Step 210, a transaction request may be received (e.g., by the second computing device) from a first computing device, wherein the received transaction request may be associated with a first protocol.

In Step 220, a type of the first protocol and a corresponding type of a second protocol may be determined based on the received transaction request. In Step 230, a characteristic of the received transaction request may be determined. In some embodiments, the characteristic is determined for at least one of: a physical connection through which the transaction request is received, and/or a communication rate of the first protocol, and/or a number of received transmissions for the received transaction request, and/or at least one predetermined character within the transaction request. In Step 235, a response corresponding to the transaction request, may be received (e.g., in the first protocol) by the first computing device.

In Step 240, the transaction request may be converted (e.g., by the second computing device) from the first protocol into the second protocol. In some embodiments, the conversion is carried out based on a predefined conversion protocols database.

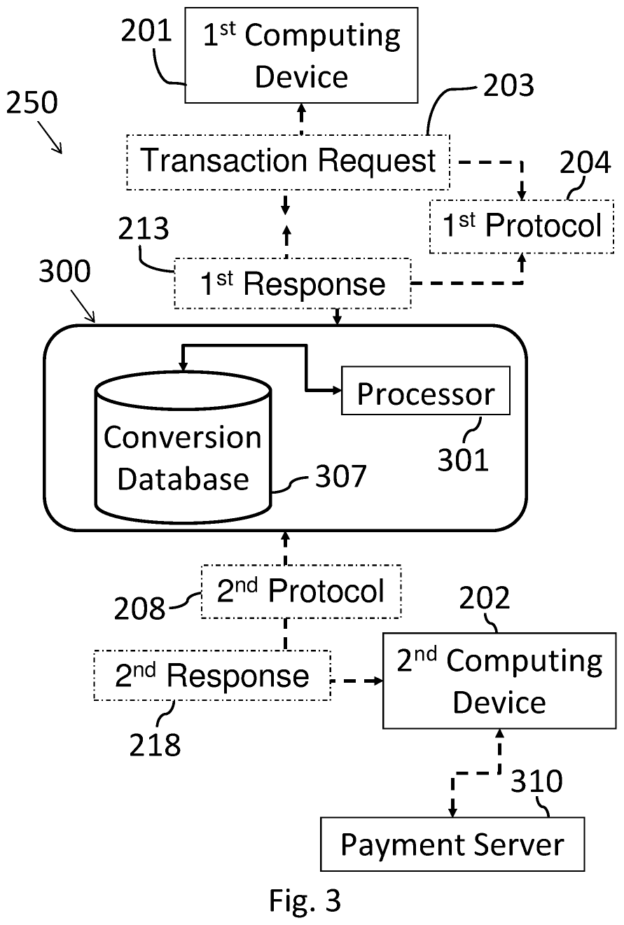

Reference is now made to FIG. 3, which shows a block diagram of a system 250 for conversion of payment protocols with a dedicated protocol conversion terminal 300, according to some embodiments. In FIG. 3, hardware elements are indicated with a solid line and the direction of arrows may indicate the direction of information flow. Some of the elements shown in FIG. 3 may be similar to the elements shown in FIG. 2A, for instance the first computing device 201.

According to some embodiments, the terminal 300 includes a processor 301 and a predefined conversion protocols database 307. The conversion protocols database 307 may be coupled to or in communication with the processor 301.

In some embodiments, the processor 301 receives a transaction request 203 from a first computing device 201, for instance similarly to the system 200 shown in FIG. 2A where the second computing device 202 receives the transaction request 203 from the first computing device 201. In some embodiments, the transaction request 203 is based on a first protocol 204.

In case that the second computing device 202 requires a different protocol for communicating with an external server in order to confirm the transaction, the terminal 300 may convert the first protocol 204 to the required second protocol. In some embodiments, the processor 301 converts the transaction request 203 from the first protocol 204 into “N” different protocols (e.g., for “N” predefined protocol types), where “N” is a natural number. The conversion may be carried out based on the predefined conversion protocols database 307.

In some embodiments, the processor 301 transmits the converted transaction request in “N” protocols to be received by a second computing device 202, and accordingly carry out the transaction upon confirmation by the second computing device 202 with at least one external payment server 310 (e.g., a credit card server or a server associated with digital wallets). In some embodiments, the confirmation of the transaction includes validating an account balance of a digital wallet associated with the second computing device 202 and associated with the payment server 310.

For example, the terminal 300 may be connected to an existing transaction platform with the first computing device 201 and the second computing device 202, such that all transaction request may be configured to pass via the terminal 300.

In some embodiments, a dedicated software (e.g., compatible to the terminal 300) is embedded at the first computing device 201 in order to send the transaction request 203 to the terminal 300, for further processing. For example, a dedicated dynamic-link library (DLL) may be used in communication between the first computing device 201 and the terminal 300, and/or in communication between the terminal 300 and the second computing device 202. For example, the second computing device 202 may be a mobile computing device such as a smartphone.

According to some embodiments, a dedicated software (e.g., compatible to the terminal 300) is embedded at the first computing device 201 and/or embedded at the second computing device 202.

In some embodiments, the terminal 300 includes a user interface (e.g., with a touchscreen) for physical identification of the transaction. For example, the user that wants to carry out the transaction may use the user interface of the terminal 300 in order to enter or confirm the details of the transaction, such as the amount to be payed or the items.

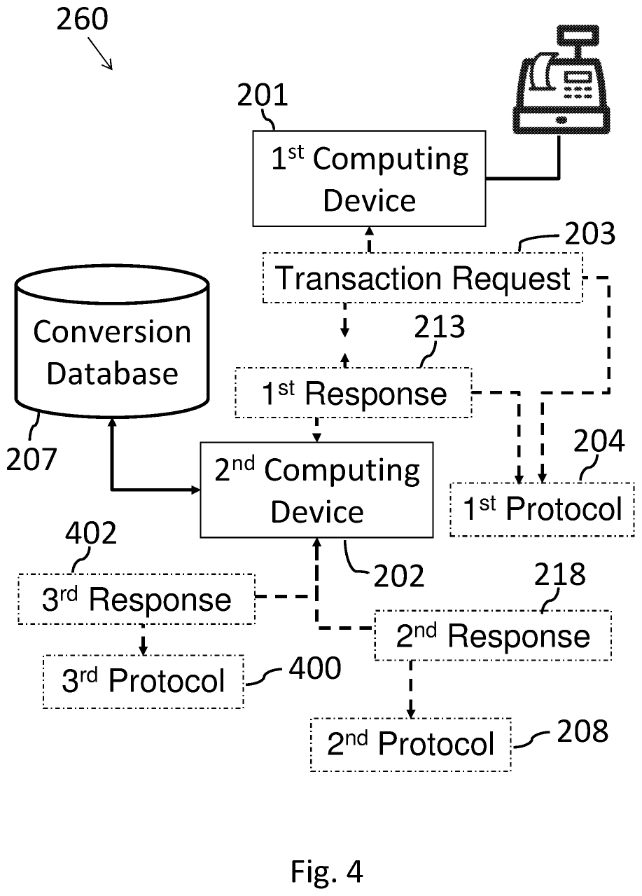

Reference is now made to FIG. 4, which shows a block diagram of a system 260 for conversion of payment protocols with a dedicated third protocol 400, according to some embodiments. In FIG. 4, hardware elements are indicated with a solid line and the direction of arrows may indicate the direction of information flow. Some of the elements shown in FIG. 4 may be similar to the elements shown in FIG. 2A or FIG. 3, for instance the first computing device 201.

According to some embodiments, the second computing device 202 converts the transaction request 203 from the first protocol 204 (e.g., the origin protocol) into a dedicated third protocol 400, based on the predefined conversion protocols database 207. The second computing device 202 may then convert the transaction request 203 from the third protocol 400 into the second protocol 208 (e.g., the destination protocol), based on the predefined conversion protocols database 207.

For example, the conversion protocols database 207 may include information for conversion from the first protocol 204 into the dedicated third protocol 400 (e.g., with a predefined protocol type). Thus, when the second computing device 202 is uncapable of directly converting the first protocol 204 into the second protocol 208 (e.g., due to algorithm difficulties), the conversion may be carried out via the conversion into an intermediate predefined third protocol 400. The conversion protocols database 207 may include information for conversion from the dedicated third protocol 400 into the second protocol 208, such that conversion of the first protocol 204 into the second protocol 208 may be carried out with an intermediate step of converting into the dedicated third protocol 400.

According to some embodiments, the second computing device 202 converts the transaction request 203 from the dedicated third protocol 400 into predefined “N” protocols, where “N” is a natural number. For instance, instead of converting the third protocol 400 into a specific second protocol 208, the dedicated third protocol 400 may be converted each time into the predefined “N” protocols, and accordingly any suitable end point may receive the transaction request 203 in the corresponding protocol. In some embodiments, the second computing device 202 receives a third response 402 in the third protocol 400, similarly to the second response 218 received in the second protocol 208. For example, the second computing device 202 may receive confirmation of the transaction as the third response 402.

In some embodiments, the first protocol 204 is analyzed and learned by the second computing device 202 or another dedicated device (e.g., the terminal 300 shown in FIG. 3), for communication with the first computing device 201. For example, such analysis and learning may be carried out to update the conversion protocols database 207. Similarly, the second protocol 208 may be analyzed and learned for communication with the second computing device 202, such that simultaneous communication with different protocols is carried out. For example, the second computing device 202 may be a mobile computing device such as a smartphone.

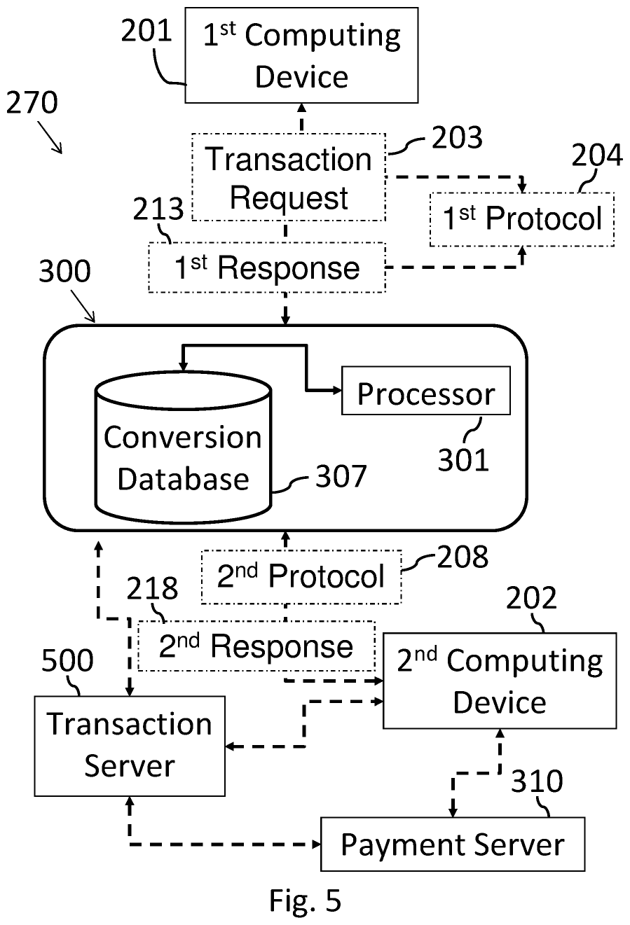

Reference is now made to FIG. 5, which shows a block diagram of a system 270 for conversion of payment protocols with at least one dedicated transaction server 500, according to some embodiments. In FIG. 5, hardware elements are indicated with a solid line and the direction of arrows may indicate the direction of information flow. Some of the elements shown in FIG. 5 may be similar to the elements shown in FIG. 2A or FIG. 3, for instance the first computing device 201.

The dedicated transaction server 500 may be configured to function as a dedicated server to facilitate transactions with new payment methods (e.g., using digital wallets) that were not previously available with the first computing device 201.

For example, when a user enters a point of sale (e.g., a small shop), a transaction request 203 may be initiated, for instance when the user desires to make a purchase. The transaction request 203 may be initiated at a cash register 201 with dedicated embedded software, where the transaction request 203 may include details for the amount of the transaction, the items to be purchased, etc. The cash register 201 may communicate (e.g., wirelessly using BLE, NFC, etc.) with a mobile computing device 202 (e.g., a smartphone) of the user, in order to send the details of the transaction request 203. For instance, the cash register 201 may communicate with the mobile computing device 202 via the dedicated terminal 300 (e.g., dedicated for digital wallets), where protocol conversion may be employed to facilitate the communication.

In case that the user prefers to complete the transaction using a digital wallet, the user may use the mobile computing device 202 in order to communicate with a corresponding payment server 310 and request to carry out the transaction based on the details of the transaction request 203. If the user's account with the digital wallet is confirmed by the payment server 310, the payment server 310 may issue a confirmation to the mobile computing device 202 and/or to the transaction server 500 that is associated with the terminal 300. The transaction server 500 may in turn send a confirmation to the terminal 300 in order to complete the transaction. The transaction may also be completed at the cash register 201 when the confirmation is received from the terminal 300 (e.g., via the corresponding first protocol).

In some embodiments, the mobile computing device 202 issues a confirmation to the transaction server 500, and the transaction server 500 may request additional confirmation back from the payment server 310 (e.g., via Internet communication).

In some embodiments, the first protocol 204 and/or the second protocol 208 is analyzed and learned by the transaction server 500, for communication with the first computing device 201 and/or the second computing device 202. For example, such analysis and learning may be carried out to update the conversion protocols database 207.

According to some embodiments, the terminal receives information of the transaction selected from the group consisting of: an amount for the transaction, a time and date of the transaction, and an item associated with the transaction. In some embodiments, the received information is validated by the second computing device (e.g., by a mobile computing device such as a smartphone). For example, a user may review the items in a particular transaction prior to completing and/or validating the transaction.

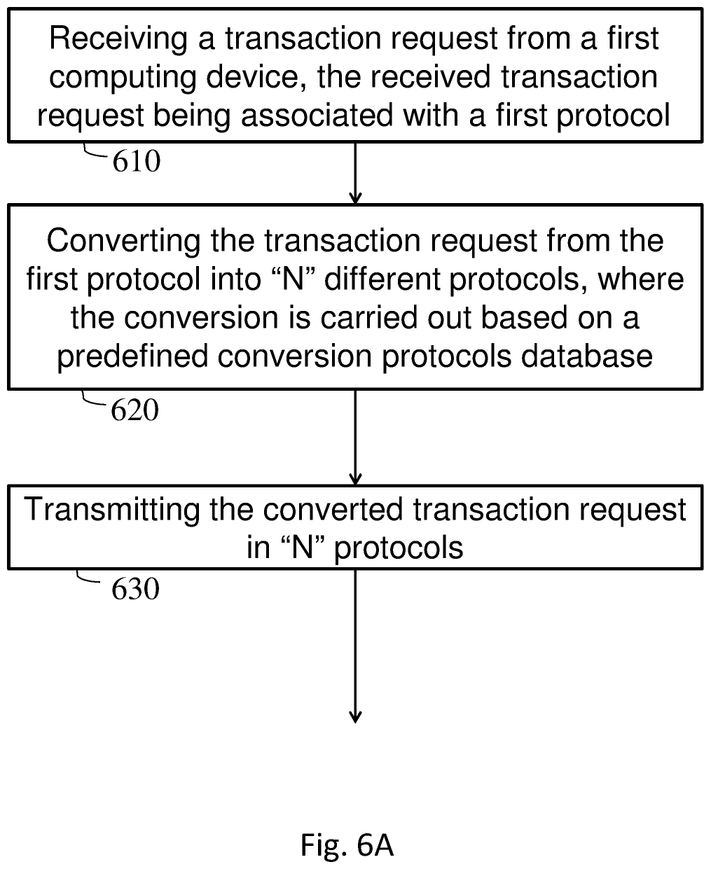

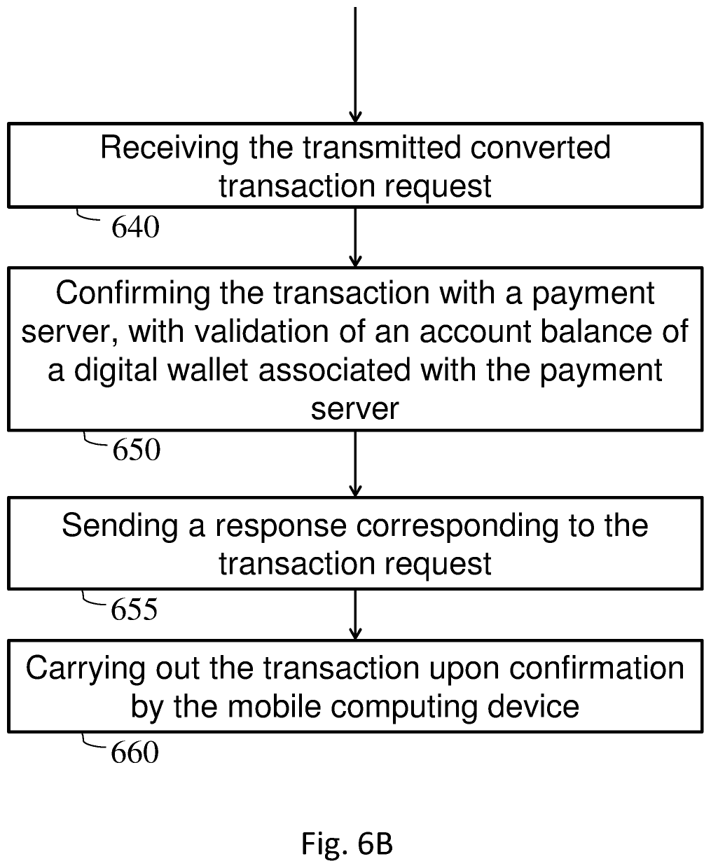

Reference is now made to FIG. 6A-6B, which show a flowchart of a method of carrying out a transaction with a digital wallet, according to some embodiments.

In Step 610, a transaction request may be received (e.g., by a terminal) from a first computing device, based on a first protocol. In Step 620, the transaction request may be converted from the first protocol into “N” different protocols. In some embodiments, the conversion is carried out based on a predefined conversion protocols database, where “N” is a natural number.

In Step 630, the converted transaction request may be transmitted in “N” protocols. In some embodiments, a plurality of different devices (e.g., smartphones) is accordingly allowed to receive the transmission in “N” protocols such that each mobile device may receive the required protocol in order to complete the transaction. For example, a particular smartphone using a protocol ‘X’ may receive the transmission in “N” protocols and utilize the corresponding protocol ‘X’ in order to carry out the transaction request using a digital wallet account, that communicates with the payment server.

In Step 640, the transmitted converted transaction request may be received, for instance by the second computing device (e.g., a mobile computing device such as a smartphone). In Step 650, the transaction may be confirmed, for instance by the second computing device (e.g., a mobile computing device such as a smartphone), with a payment server. For example, the payment server may be a server associated with a particular digital wallet. In some embodiments, confirmation of the transaction includes validating an account balance of a digital wallet associated with the mobile computing device and/or associated with the payment server. For example, the account balance may be associated with a balance of a currency and/or balance of loyalty points. In Step 655, a response may be sent to the first computing device, for instance the response may correspond to the transaction request. For example, the response (e.g., converted into the first protocol) may include the confirmation.

In Step 660, the transaction may be carried out (e.g., by the terminal), upon confirmation by the mobile computing device.

According to some embodiments, at least one of the systems 200, 220, 250, 260 and 270 (shown in FIGS. 2A, 2B, 3, 4 and 5, respectively) for conversion of payment protocols, may be implemented with at least one mobile computing device. The at least one mobile computing device may include dedicated hardware components configured to perform at least some of the processes carried out by the first computing device. For example, the at least one mobile computing device may replace a digital cash register such that the at least one mobile computing device may carry out the transactions.

Accordingly, the at least one mobile computing device may receive a transaction request and communicate that transaction request to the second computing device. For example, the at least one mobile computing device may be positioned at a point of sale (e.g., at a store) and receive (manually or automatically) a request to initiate a transaction, such a request may include an amount to be paid to complete a transaction. In some embodiments, the second computing device receives the transaction request, and return a corresponding response (in the first protocol) to the at least one mobile computing device. When communication between the at least one mobile computing device and additional transaction entities is enabled (e.g., credit card servers or digital wallets), by converting between the protocols it may be avoided to integrate new dedicated software into every computing device (e.g., for every single type of new transaction method).

While certain features of the invention have been illustrated and described herein, many modifications, substitutions, changes, and equivalents may occur to those skilled in the art. It is, therefore, to be understood that the appended claims are intended to cover all such modifications and changes as fall within the invention.

Various embodiments have been presented. Each of these embodiments may, of course, include features from other embodiments presented, and embodiments not specifically described may include various features described herein.

1-8. (canceled)

9. A method of carrying out a transaction with a digital wallet, the method comprising:
receiving, by a terminal, a transaction request from a first computing device, based on a first protocol;
converting, by the terminal, the transaction request from the first protocol into “N” different protocols, wherein the conversion is carried out based on a predefined conversion protocols database, and wherein “N” is a natural number;
transmitting, by the terminal, the converted transaction request in “N” protocols;
receiving, by a mobile computing device, the transmitted converted transaction request;
confirming, by the mobile computing device, the transaction with a payment server, wherein confirmation of the transaction comprises validating an account balance of a digital wallet associated with the mobile computing device and associated with the payment server; and
carrying out the transaction, by the terminal, upon confirmation by the mobile computing device.

10. The method of claim 9, wherein the conversion from the first protocol into “N” protocols comprises:
converting the transaction request from the first protocol into a third protocol; and
converting the transaction request from the third protocol into the “N” protocols, wherein the conversion is carried out based on the predefined conversion protocols database.

11. The method of claim 9, further comprising:
receiving, by the terminal, information of the transaction selected from the group consisting of: an amount for the transaction, a time and date of the transaction, and an item associated with the transaction; and
validating the received information by the mobile computing device.

12. The method of claim 9, further comprising determining a characteristic of the received transaction request, for at least one of:
a physical connection through which the transaction request is received;
a communication rate of the first protocol;
a number of received transmissions for the received transaction request; and
at least one predetermined character within the transaction request,
wherein the determined characteristic is different in the first protocol and in the converted “N” protocols.

13. The method of claim 9, further comprising carrying out the transaction, by the terminal, upon confirmation by the mobile computing device, when at least one transaction server validates the transaction.

14. The method of claim 9, further comprising analyzing the type of the first protocol from the received transaction request.

15. The method of claim 9, wherein the payment server is associated with at least one digital wallet.

16-20. (canceled)
